(19) United States
(12) Patent Application Publication
(10) Pub. No.: US 2007/0153075 A1
(43) Pub. Date: Jul. 5, 2007

(54) INKJET PRINTING SYSTEM AND METHOD OF MANUFACTURING DISPLAY DEVICE USING THE SAME

(75) Inventor: Dong-Won LEE, Seongnam-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/565,248

(22) Filed: Nov. 30, 2006

(30) Foreign Application Priority Data
Jan. 5, 2006 (KR) 10-2006-0001239

(51) Int. Cl. B41J 2/01

(52) U.S. Cl. 347/102

(57) ABSTRACT

An inkjet printing system includes a stage having a substrate mounted thereon, a head unit for dripping ink onto the substrate, a drying unit for drying the ink dripped onto the substrate, and a moving device for moving the head unit and the drying unit to predetermined positions, wherein the drying unit includes vacuum holes.

This application claims priority to Korean Patent Application No. 10-2006-0001239, filed on Jan. 5, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to an inkjet printing system and a method of manufacturing a display device using the same.

(b) Description of the Related Art

Generally, various thin film patterns of flat panel displays, such as a liquid crystal display (“LCD”) and an organic light emitting diode (“OLED”) display, are formed through a photolithography process. A lager-sized flat panel display necessitates an increase in quantity of materials, such as a photosensitive film applied on a substrate to form a thin film pattern. This may also increase manufacturing costs and require much larger manufacturing equipment to perform the photolithography process.

In order to minimize the above problems, an inkjet printing system which forms a thin film pattern by dripping ink has been developed. However, a thin film formed with such an inkjet printing system may have a non-uniform profile and thickness, and this may cause non-uniformity of the transmittance and emission characteristics of light which is emitted from the display device. Since the non-uniformity is developed during the period from the time the ink is dripped onto a substrate to the time that ink is dried and hardened, the substrate onto which the ink is dripped is put into an additional drying chamber which is capable of adjusting the drying process.

According to such a conventional inkjet printing system, the ink begins to evaporate immediately after it is dripped because the ink solvents used in the inkjet printing system have high vapor pressure and the size of the ink drops is very small. Therefore, the uniformity of the thin film may deteriorate because the ink is partially dried before putting it into a drying chamber, it is difficult to adjust the drying process, and also because there is a difference in the speed of drying at the boundary region of the printing area.

### BRIEF SUMMARY OF THE INVENTION

The present invention includes an inkjet printing system and a method of manufacturing a display device using the same which can dry ink faster and form a thin film having a uniform profile and thickness.

An exemplary embodiment of an inkjet printing system according to the present invention includes; a substrate mounted on a stage, a head unit dripping ink onto the substrate, a drying unit drying the ink dripped onto the substrate, and a moving device moving the head unit and the drying unit to predetermined positions, wherein vacuum holes are formed in the drying unit.

The drying unit may be disposed away form the head unit at a predetermined interval in a direction substantially perpendicular to a moving direction of the head unit.

The drying unit may further include a heater.

The heater may be disposed between the vacuum holes.

The head unit may include an inkjet head having a plurality of nozzles.

The substrate may be one of a substrate for a liquid crystal display (“LCD”) and a substrate for an organic light emitting diode (“OLED”) display.

The ink may be one of ink for color filters and ink for forming organic light emitting members.

A partition member may be formed on the substrate to confine the dripped ink.

The partition member may be one of a light blocking member of an LCD and a partition of an OLED display.

An exemplary embodiment of a method of manufacturing a display device according to the present invention includes; disposing a head unit above a substrate, dripping ink onto the substrate through the head unit while moving the head unit, and drying the dripped ink with a drying unit adjacent to the head unit, wherein the drying unit may include vacuum holes.

The drying unit may be disposed away from the head unit at a predetermined interval in a direction substantially perpendicular to a moving direction of the head unit.

The method may further include heating the ink on the substrate through a heater on the drying unit.

The head unit may include an inkjet head having a plurality of nozzles.

The substrate may be one of a substrate for a liquid crystal display (“LCD”) and a substrate for an organic light emitting diode (“OLED”) display.

The ink may be one of ink for color filters and ink for organic light emitting members.

The method may further include forming a partition member on the substrate to confine the dripped ink.

The partition member may be formed to be one of a light blocking member of an LCD and a partition of an OLED display.

### BRIEF DESCRIPTION OF THE DRAWINGS

The above and/or other aspects, features and advantages of the present invention will become apparent and more readily appreciated from the following description of exemplary embodiments, taken in conjunction with the accompany drawings of which:

FIG. 1 is a top perspective view of an exemplary embodiment of an inkjet printing system according to the present invention;

FIG. 2 is a view of an exemplary embodiment of a head unit and a moving device of an inkjet printing system as seen from below according to the present invention;

FIG. 3 is a cross-sectional view illustrating an exemplary embodiment of an ink printing method with an inkjet head of an inkjet printing system according to the present invention;

FIG. 4 is a schematic view illustrating a drying state of dripped ink using an exemplary embodiment of a drying unit of an exemplary embodiment of an inkjet printing system according to the present invention;

FIG. 5 is a top plan layout view of an exemplary embodiment of a liquid crystal display (“LCD”) manufactured using an exemplary embodiment of an inkjet printing system according to the present invention;

FIG. 6 is a cross-sectional view of the exemplary embodiment of an LCD manufactured using an exemplary embodiment of an inkjet printing system according to the present invention taken along line VI-VI of FIG. 5;

FIG. 7 is an equivalent circuit diagram of an exemplary embodiment of an OLED display according to the present invention;

FIG. 8 is a top plan layout view of an exemplary embodiment of an organic light emitting diode (“OLED”) display manufactured using an exemplary embodiment of an inkjet printing system according to the present invention; and

FIG. 9 is a cross-sectional view of the exemplary embodiment of an OLED display manufactured using an exemplary embodiment of an inkjet printing system according to the present invention taken along line IX-IX of FIG. 8.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

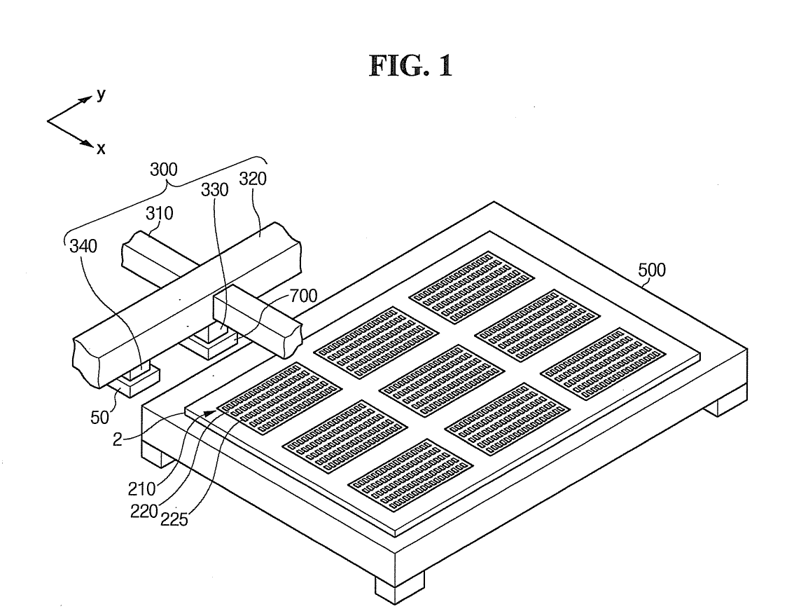

An exemplary embodiment of an inkjet printing system according to the present invention will now be described in detail with reference to FIGS. 1-4.

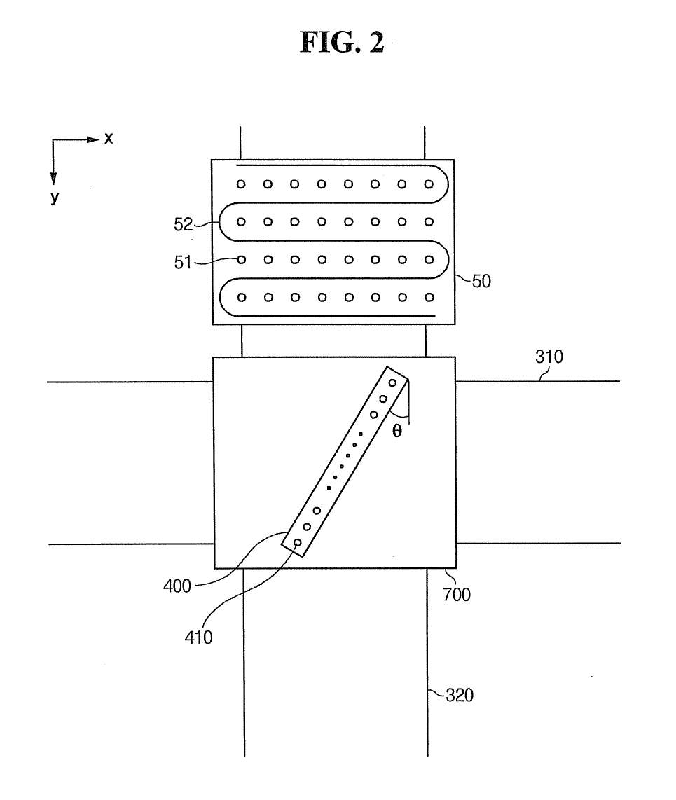

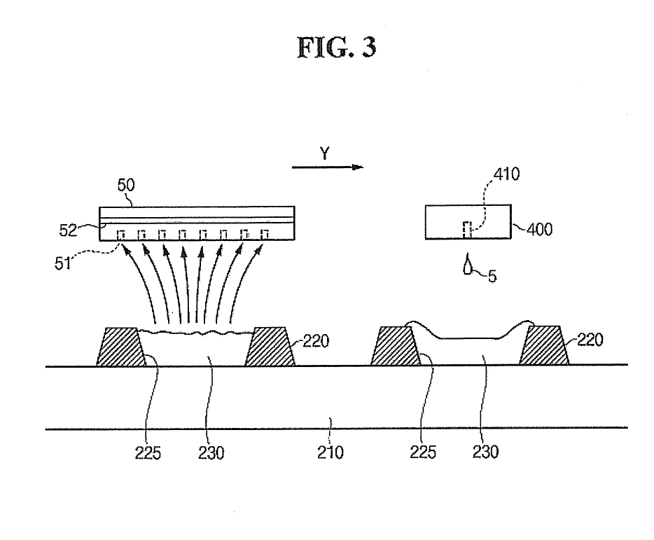

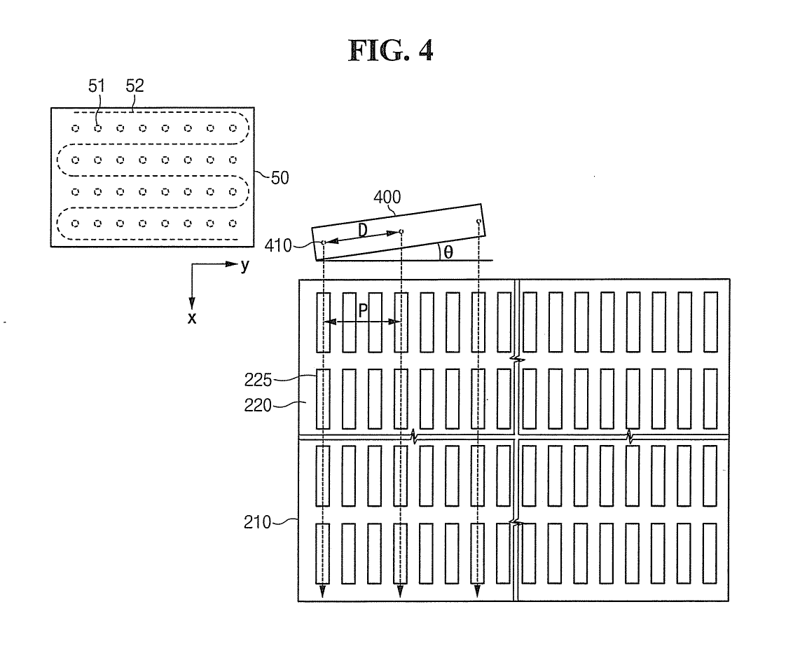

FIG. 1 is a top perspective view of exemplary embodiment of an inkjet printing system according to the present invention, FIG. 2 is a view of an exemplary embodiment of a head unit, a drying unit, and a moving unit of an inkjet printing system as seen from below according to the present invention, FIG. 3 is a cross-sectional view illustrating an exemplary embodiment of an ink printing method using an inkjet head of an inkjet printing system according to the present invention, and FIG. 4 is a schematic view illustrating a drying state of dripped ink using an exemplary embodiment of a drying unit of an exemplary embodiment of an inkjet printing system according to the present invention.

As shown in FIGS. 1-4, the inkjet printing system includes a stage 500 having a mother substrate 2 mounted thereon, a head unit 700 disposed above the stage 500 by a predetermined interval, a drying unit 50 disposed away from the head unit 700, and a moving device 300 for moving the head unit 700 and the drying unit 50 to predetermined positions.

In one exemplary embodiment the stage 500 is larger than the mother substrate 2 such that it supports the mother substrate 2 thereon. The mother substrate 2 is composed of a plurality of substrates 210. The plurality of substrates 210 may be used as a supporting board such as a color filter array panel of a liquid crystal display (“LCD”) or a thin film transistor array panel of an organic light emitting diode (“OLED”) display.

As shown in FIG. 1, an exemplary embodiment of the mother substrate 2 for forming a color filter array panel of an LCD is illustrated, and a light blocking member 220 having a plurality of openings 225 is formed on each of the plurality of substrates 210.

As shown in FIG. 2, the head unit 700 includes an inkjet head 400. The inkjet head 400 has a long rod-shape and a bottom surface with a plurality of nozzles 410 attached thereon. As shown in FIG. 3 ink 5 is dripped onto the substrate 210 through the nozzles 410. The ink includes a solvent and a solution. As shown in FIGS. 2 and 4, the inkjet head 400 is inclined in the Y direction at a predetermined angle θ. Since a nozzle pitch D, which is a distance between two adjacent nozzles 410 in the inkjet head 400, differs from a pixel pitch P, which is a distance between two pixels to be printed, the inkjet head 400 is rotated at the predetermined angle 0 so as to match the distance between ink drops dripped from the nozzles 410 with the distance between pixels to be filled. Although only one inkjet head 400 is shown in FIG. 2, alternative exemplary embodiments include configurations where a plurality of inkjet heads may be provided.

The drying unit 50 is disposed above the stage 500 by a predetermined interval and is also disposed away from the head unit 700 at a predetermined interval in the Y direction. The drying unit 50 includes a plurality of vacuum holes 51 and a heater 52. The heater 52 may be formed in a plate-shape or a winding shape among the vacuum holes 51. Once the ink 5 is dripped onto the substrate 210 it is dried by absorbing the solvent of the ink through the vacuum holes and radiating heat through the heater 52.

The moving device 300 includes a Y direction mover 310 for positioning the head unit 700 and the drying unit 50 above the substrate 210 at a predetermined interval and moving the head unit 700 and the drying unit 50 in the Y direction, an X direction mover 320 for moving the head unit 700 and the drying unit 50 in the X direction, and lifters 330 and 340 for respectively lifting the head unit 700 and the drying unit 50.

The process of forming color filters on the substrate 210 using the inkjet printing system having the above-mentioned structure will now be described in detail with reference to FIGS. 1-4.

First, the head unit 700 is disposed at a predetermined position above the substrate 210 by the operation of the X and Y direction movers 320 or 310 and the lifter 330 of the moving device 300 in the inkjet printing system.

Next, the X direction mover 320 of the moving device 300 and the nozzles 410 of the head unit 700 are driven to move the head unit 700 in the X direction while dripping the ink 5 in a row as shown by the dotted lines in FIG. 4.

Then, the head unit 700 is moved by a predetermined interval in the Y direction to a row adjacent to the row in which the ink 5 was just dripped, and the ink 5 is again dripped in a row in the X direction. At this time, the drying unit 50 spaced apart from the head unit 700 by a predetermined interval in the Y direction is moved to dry the ink 5 in the X direction along the row in which the ink 5 has just been dripped. In one exemplary embodiment it is possible to dry the ink 5 by simultaneously using the vacuum holes 51 and the heater 52.

In another exemplary embodiment the ink 5 is dried by the drying unit 50 at almost the same time as the head unit 700 drips the ink 5 and to adjust the time and condition of the drying operation to thereby improve the uniformity of the profile and thickness of the color filters 230.

Moreover, it is possible to prevent a small amount of solvent from evaporating from the ink and contaminating the head unit 700 by drying the ink 5 quickly after dripping.

The exemplary embodiment of a display panel manufactured by the inkjet printing system according to the present invention may be a color filter array panel of an LCD or a thin film transistor array panel of an OLED display. It is possible to form color filters of a liquid crystal display or organic light emitting members of an OLED display through the exemplary embodiment of an inkjet printing system according to the present invention.

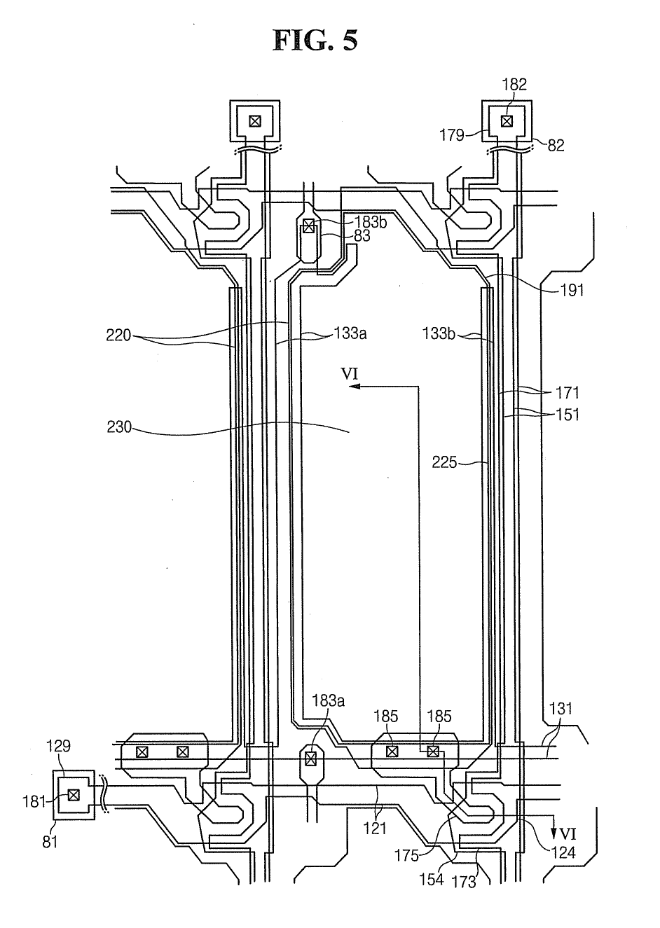

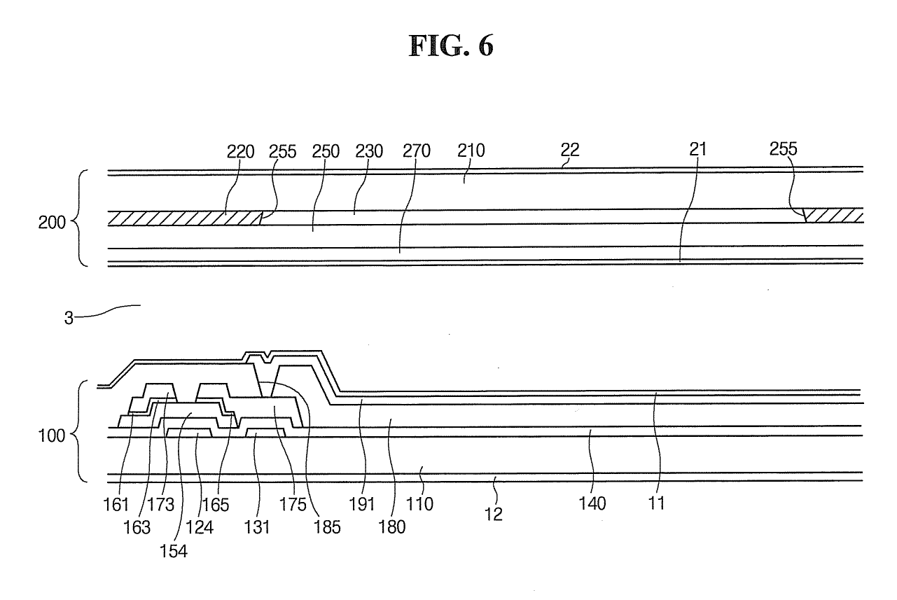

FIG. 5 is a top plan layout view of an exemplary embodiment of an LCD manufactured using an exemplary embodiment of an inkjet printing system according to the present invention, and FIG. 6 is a cross-sectional view of the exemplary embodiment of an LCD manufactured using an exemplary embodiment of an inkjet printing system according to the present invention taken along line VI-VI of FIG. 5.

As shown in FIG. 5 and FIG. 6, an exemplary embodiment of the liquid crystal display includes a lower thin film transistor array panel 100, an upper color filter array panel 200 facing the thin film transistor array panel 100, and a liquid crystal layer 3 interposed between the thin film transistor array panel 100 and the color filter array panel 200.

The thin film transistor array panel 100 will now be described in detail with reference to FIG. 5 and FIG. 6.

A plurality of gate lines 121 and a plurality of storage electrode lines 131 are formed on an insulation substrate 110, exemplary embodiments of which are made of transparent glass or plastic. The gate lines 121 transfer gate signals and extend basically in a horizontal direction. Each of the gate lines 121 includes a plurality of gate electrodes 124 which protrude upward and downward, thereby extending a contact surface area of the gate lines 121, and a wide end 129 which may be used for connecting with another layer or an external driving circuit. The storage electrode lines 131 receive a predetermined voltage, and have trunk lines extending to run almost parallel to the gate lines 121 and a plurality of pairs of first and second storage electrodes 133a and 133b branching off from the trunk lines. Each of the storage electrode lines 131 is disposed between two adjacent gate lines 121, and the trunk line is disposed closer to the lower one of the two adjacent gate lines 121.

A gate insulating layer 140, exemplary embodiments of which are made of silicon nitride (“SiNx”) or silicon oxide (“SiOx”), is formed on the gate lines 121 and the storage electrode lines 131.

A plurality of semiconductor stripes 151, exemplary embodiments of which are made of hydrogenated amorphous silicon (“a-Si”) or polysilicon, are formed on the gate insulating layer 140. The semiconductor stripes 151 extend mainly in a vertical direction and have a plurality of projections 154 which protrude toward the gate electrodes 124. The semiconductor stripes 151 become wider around the gate lines 121 and the storage electrode lines 131 so as to cover them.

A plurality of ohmic contact stripes and islands 161 and 165 are formed on the semiconductors 151. Exemplary embodiments of the ohmic contacts 161 and 165 may be made of silicide or n+hydrogenated amorphous silicon in which an n-type impurity such as phosphorus is highly doped. The ohmic contact stripes 161 have a plurality of projections 163, and the projections 163 and the ohmic contact islands 165 form pairs to be disposed opposite one another on the projections 154 of the semiconductors 151.

A plurality of data lines 171 and a plurality of drain electrodes 175 are formed on the ohmic contacts 161 and 165 and the gate insulating layer 140.

The data lines 171 transfer data signals and extend mainly in a vertical direction to cross the gate lines 121. The data lines 171 also cross the storage electrode lines 131 to run between the sets of adjacent storage electrode branches 133a and 133b.

Each of the data lines 171 has a plurality of source electrodes 173 extending toward the gate electrodes 124 and a wide end 179 which may be used for connecting with another layer or an external driving circuit.

The drain electrodes 175 are separated from the data lines 171 and face the source electrodes 173 with the gate electrodes 124 interposed therebetween. Each of the drain electrodes 175 has one wide end and one narrower projecting end. The wide end is overlapped with the storage electrode 131, and the rod-shaped end is partially surrounded by the source electrode 173 projecting from the data line 171.

A thin film transistor (“TFT”) is made of one gate electrode 124, one source electrode 173, and one drain electrode 175 together with the projection 154 of the semiconductor 151, and the channel of the TFT is formed on the projection 154 between the source electrode 173 and the drain electrode 175.

The ohmic contacts 161 and 165 are placed between the semiconductors 151 and the data lines 171 and drain electrodes 175 to reduce the resistance therebetween.

A passivation layer 180 is formed on the data lines 171, the drain electrodes 175, and exposed portions of the semiconductor stripes 151 and projections on the semiconductor stripes 154. Exemplary embodiments of the passivation layer 180 may be made of an inorganic insulator or an organic insulator, and its surface may be flat.

A plurality of contact holes 181, 182 and 185 are formed in the passivation layer 180 to expose the ends 179 of the data lines 171, the ends of the gate lines 129 and the drain electrodes 175. A plurality of contact holes 181 are formed in the passivation layer 180 and the gate insulating layer 140, to expose the ends 129 of the gate lines 121, a plurality of contact holes 183a are formed to expose parts of the storage electrode lines 131 around base ends of the first storage electrode branches 133a, and a plurality of contact holes 183b are formed to expose projections of the ends of the first storage electrode branches 133a opposite the base ends.

A plurality of pixel electrodes 191, a plurality of overpasses 83, and a plurality of contact assistants 81 and 82 are formed on the passivation layer 180.

The pixel electrodes 191 are physically and electrically connected to the drain electrodes 175 through the contact holes 185, and receive data voltages from the drain electrodes 175. The pixel electrodes 191 to which a data voltage is applied generate electric fields together with a common electrode 270 of the display panel 200 to which a common voltage is applied so as to determine the orientation of liquid crystal molecules of the liquid crystal layer 3 between the pixel electrodes 191 and the common electrode 270. The polarization of light which passes through the liquid crystal layer varies depending on the orientation of the liquid crystal molecules. The pixel electrodes 191 and the common electrode 270 form capacitors (hereinafter, referred to as liquid crystal capacitors) to maintain the applied voltage even after the thin film transistor is turned off.

The pixel electrodes 191 and the drain electrodes 175 connected to the pixel electrodes 191 are overlapped with the storage electrodes 133a and 133b and the storage electrode lines 131. Capacitors formed by overlapping the pixel electrodes 191 and the drain electrodes 175 which are electrically connected to the pixel electrodes 191 with the storage electrode lines 131 are called storage capacitors, and they enhance the voltage maintaining ability of the liquid crystal capacitors.

The contact assistants 81 and 82 are connected to the wide ends 129 of the gate lines 121 and the wide ends 179 of the data lines 171 through the contact holes 181 and 182, respectively. The contact assistants 81 and 82 supplement the connectivity of the wide ends 129 of the gate lines 121 and the wide ends 179 of the data lines 171 to an external device and also may function to protect them from corrosive substances or abrasion.

The overpasses 83 are laid across the gate lines 121 and are connected to the portions of the storage electrode lines 131 which are exposed by the contact hole 183a and the free ends of the storage electrodes 133b which are exposed by the contact hole 183b with the gate lines 121 placed therebetween. The storage electrodes 133a and 133b and the storage electrode lines 131 may be used together with the overpasses 83 to compensate for defects of the gate lines 121, the data lines 171, or the thin film transistors.

A method of manufacturing the upper color filter array panel 200 shown in FIG. 5 and FIG. 6 will now be described in detail.

A light blocking member 220 is formed on the insulation substrate 210, exemplary embodiments of which are made of transparent glass or plastic. The light blocking member 220 is also called a black matrix and prevents light leakage. The light blocking member 220 has a plurality of openings 225 which face the pixel electrodes 191 and have substantially the same shape as the pixel electrodes 191, and prevents light leakage from between the pixel electrodes 191. The light blocking member 220 may consist of a portion corresponding to the gate lines 121 and the data lines 171 and another portion corresponding to the thin film transistor. The light blocking member 220 may also function as a partition member to confine ink for color filters in the manufacturing process of the color filter array panel using the inkjet printing system.

A plurality of color filters 230, exemplary embodiments of which may be formed by the inkjet printing system, are placed on the openings 225 of the light blocking member 220

The color filters 230 are mainly placed in the region surrounded by the light blocking member 220 and may extend along the column of the pixel electrodes 191 in a vertical direction. Each of the color filters 230 may display one of three primary colors exemplary embodiments of which are red, green, and blue.

An overcoat 250 is formed on the color filters 230 and the light blocking member 220. The overcoat 250, exemplary embodiments of which are made of one of an organic insulator and an inorganic insulator, prevents the color filters 230 from being exposed and provides a flat surface. Alternative exemplary embodiments include configurations where the overcoat 250 may be omitted.

A common electrode 270 is formed on the overcoat 250. Exemplary embodiments of the common electrode 270 may be made of a transparent conductor such as indium tin oxide (“ITO”) or indium zinc oxide (“IZO”).

Alignment layers 11 and 21 are applied on the inner surface of the display panels 100 and 200, and they may be horizontal alignment layers or vertical alignment layers. Polarizers 12 and 22 are provided on the external surface of the display panels 100 and 200. The polarization axes of the two polarizers 12 and 22 are perpendicular to each other, and in one exemplary embodiment one of the two polarization axes is parallel to the gate lines 121. In the exemplary embodiment of an LCD wherein the LCD is a reflective liquid crystal display, one of the two polarizers 12 and 22 may be omitted.

The method of manufacturing the color filter array panel shown in FIG. 5 and FIG. 6 will now be described in detail.

First, the light blocking member 220 including the plurality of openings 225 is formed by forming a metal layer, exemplary embodiments of which include Cr, on the insulation substrate 210, exemplary embodiments of which are made of a transparent material such as glass by a vacuum deposition process, and performing photolithography on the deposited metal layer. In an alternative exemplary embodiment the light blocking member 220 may be formed by stacking a polymer resin solution on the insulation substrate 210 and performing spin coating and photolithography processes. The light blocking member 220 may be formed through various other well-known techniques.

Next, the color filters 230 are formed in the openings 225 of the light blocking member 220 by the inkjet printing system. Referring to FIG. 3, the color filters 230 are formed by dripping the ink 5, exemplary embodiments of which are liquid pigment pastes corresponding to red, green, and blue color filters, into the openings 225 through the nozzles 410 while moving the head unit 700, to fill the openings 225. Then, the drying unit 50 adjacent to the head unit 700 is positioned above the dripped ink to dry the ink 5 by vacuum and heat, thereby completing the color filters 230. Therefore, the profile and thickness of the color filters 230 may be made uniform.

Next, the overcoat 250 is formed on the color filters 230 and the light blocking member 220. Then, the common electrode 270 is formed on the overcoat 250 with a transparent conductor such as ITO or IZO.

Hereinafter, an exemplary embodiment of an OLED display manufactured using an inkjet printing system according to the present invention will be described.

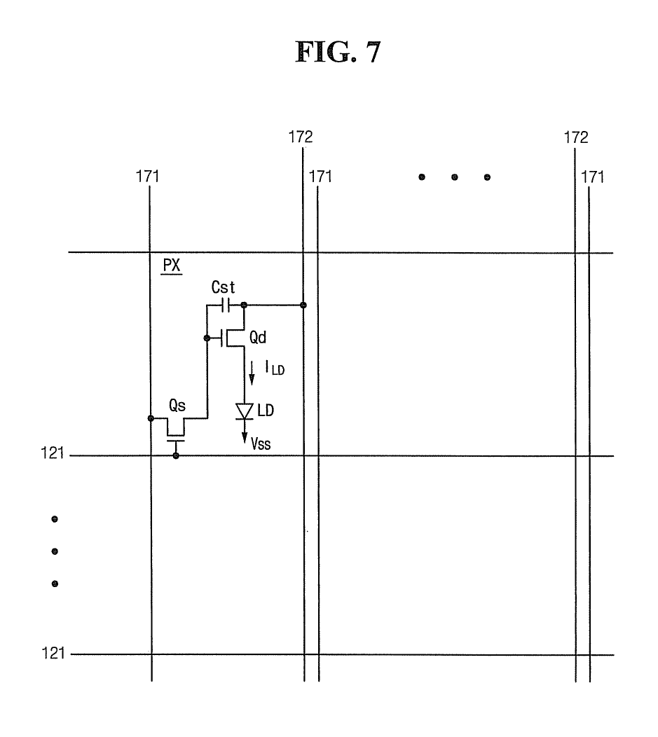

An equivalent circuit diagram of an exemplary embodiment of an OLED display manufactured using exemplary embodiment of an inkjet printing system according to the present invention will now be described with reference to FIG. 7. FIG. 7 is an equivalent circuit diagram of an exemplary embodiment of an OLED display according to the present invention.

Referring to FIG. 7, the exemplary embodiment of an OLED display manufactured using the exemplary embodiment of an inkjet printing system according to the present invention includes a plurality of signal lines 121, 171, and 172, and a plurality of pixels PX which are connected to the signal lines 121, 171, and 172 and arranged in substantially a matrix pattern.

The signal lines includes a plurality of gate lines 121 for transferring gate signals or scanning signals, a plurality of data lines 171 for transferring data signals, and a plurality of driving voltage lines 172 for transferring driving voltages. The gate lines 121 extend basically in a row direction to run substantially parallel to each other, while the data lines 171 and the driving voltage lines 172 extend basically in a column direction to run substantially parallel to each other and substantially perpendicular to the gate lines 121.

Each of the pixels PX includes a switching transistor Qs, a driving transistor Qd, a storage capacitor Cst, and an OLED LD.

The switching transistor Qs includes a control terminal, an input terminal, and an output terminal. The control terminal is connected to the gate line 121, the input terminal is connected to the data line 171, and the output terminal is connected to the driving transistor Qd and one end of the storage capacitor Cst. The switching transistor Qs transfers a data signal supplied to the data line 171 to the driving transistor Qd in response to a scanning signal supplied to the gate line 121.

The driving transistor Qd also includes a control terminal, an input terminal, and an output terminal. The control terminal is connected to the switching transistor Qs and one side of the storage capacitor Cst, the input terminal is connected to the driving voltage line 172 and the other side of the storage capacitor Cst, and the output terminal is connected to the organic light emitting diode “OLED” LD. The driving transistor Qd flows an output current ILD having a magnitude which varies depending on a voltage difference between the control terminal and the output terminal.

The capacitor Cst is connected between the control terminal and the input terminal of the driving transistor Qd. The capacitor Cst charges a data signal supplied to the control terminal of the driving transistor Qd and sustains the charged data signal even after the switching transistor Qs is turned off.

The OLED LD includes an anode connected to the output terminal of the driving transistor Qd and a cathode connected to a common voltage Vss. The OLED LD emits light with varying intensity according to the output current ILD of the driving transistor Qd. A plurality of OLED LDs may work in conjunction so as to display images.

In the current exemplary embodiment the switching transistor Qs and the driving transistor Qd are n-channel electric field transistors (“FETs”). However, alternative exemplary embodiments include configurations wherein at least one of the switching transistor Qs and the driving transistor Qd may be a p-channel electric field transistor. Also, alternative exemplary embodiments include configurations wherein the connecting relationships among the transistors Qs and Qd, the capacitor Cst, and the OLED LD may be different.

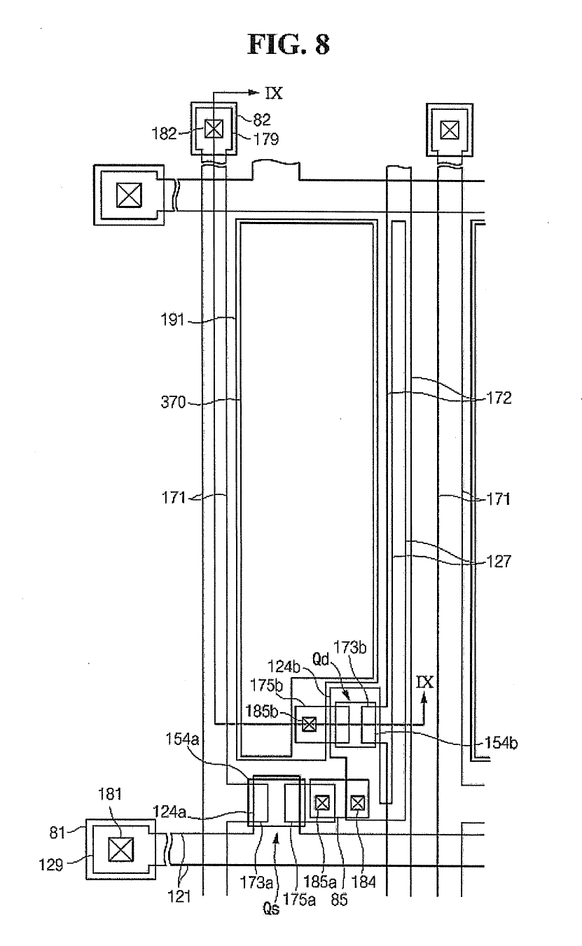

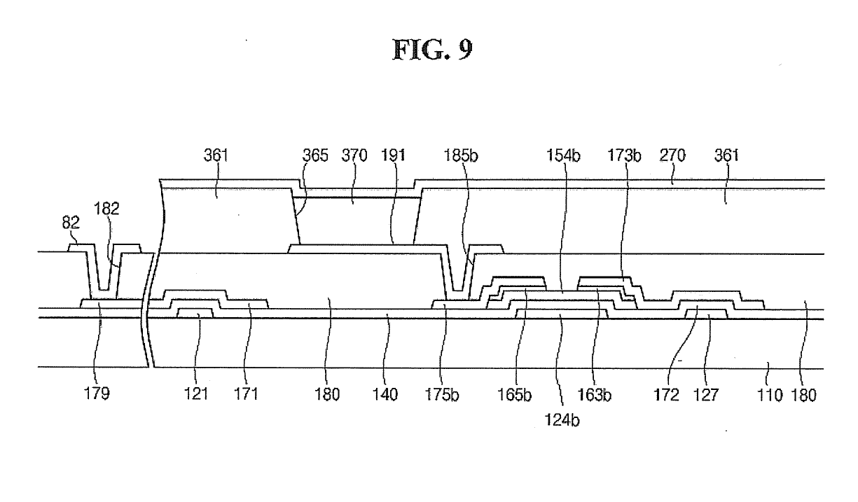

The structure of a display panel for the OLED display shown in FIG. 7 will now be described in detail with reference to FIG. 8 and FIG. 9.

FIG. 8 is a top plan layout view of an exemplary embodiment of an organic light emitting diode display panel for an OLED display manufactured using an exemplary embodiment of an inkjet printing system according to the present invention, and FIG. 9 is a cross-sectional view of the exemplary embodiment of an OLED display panel shown in FIG. 8 taken along line IX-IX.

As shown in FIG. 8 and FIG. 9, a plurality of gate lines 121 having a first control electrode 124a and a plurality of gate conductors having a plurality of second control electrodes 124b are formed on an insulation substrate 110. Exemplary embodiments of the insulation substrate 110 may be made of transparent glass or plastic.

The gate lines 121 transfer gate signals and extend basically in a horizontal direction. Each of the gate lines 121 may include a wide end 129 for connecting with another layer or an external driving circuit. The first control electrode 124a extends upward from the gate line 121. In an alternative exemplary embodiment, if a gate driving circuit (not shown) for generating gate signals is integrated on the substrate 110, the gate lines 121 may extend to be directly connected to the gate driving circuit.

The second control electrodes 124b are separated from the gate lines 121 and include storage electrodes 127 which extend downward, bend away from the storage electrodes 127, and then extend upward.

Exemplary embodiments of the gate conductors 121, 124a and 124b are made of an aluminum (Al) group metal including Al and an Al alloy, a silver (Ag) group metal including Ag and a Ag alloy, a copper (Cu) group metal including Cu and a Cu alloy, a molybdenum (Mo) group metal including Mo and a Mo alloy, chromium (Cr), tantalum (Ta), or titanium (Ti).

A gate insulating layer 140 is formed on the gate conductors 121, 124a and 124b. Exemplary embodiments of the gate insulating layer 140 may be made of silicon nitride (“SiNx”) or silicon oxide (“SiOx”).

A plurality of first and second semiconductor islands 154a and 154b are formed on the gate insulating layer 140. Exemplary embodiments of the first and second semiconductor islands 154a and 154b may be made of hydrogenated amorphous silicon or polysilicon. The first and second semiconductor islands 154a and 154b are disposed on the first and second control electrodes 124a and 124b, respectively.

A plurality of pairs of first ohmic contacts (not shown) and a plurality of pairs of second ohmic contacts 163b and 165b are formed on the first and second semiconductors islands 154a and 154b, respectively. Exemplary embodiments of the first ohmic contacts and the second ohmic contacts 165a, and 165b have an island shape and are made of n+ hydrogenated amorphous silicon in which an n-type impurity is heavily doped at a high concentration or silicide. The first ohmic contacts form a pair to be disposed on the first semiconductor island 154a and the second ohmic contacts 163b and 165b also form a pair to be disposed on the second semiconductor island 154b.

A plurality of data conductors are formed on the first ohmic contacts and second ohmic contacts 165a, and 165b and the gate insulating layer 140. Each of the data conductors includes a plurality of data lines 171, a plurality of driving voltage lines 172, and a plurality of first and second output electrodes 175a and 175b.

The data lines 171 transfer data signals and extend substantially in a vertical direction to cross the gate lines 121. Each of the data lines 171 includes a plurality of first input electrodes 173a which extend toward the first control electrode 124a and a wide end 179 which may be used for contacting with another layer or an external driving circuit.

The driving voltage lines 172 transfer driving voltages and extend substantially in a vertical direction to cross the gate lines 121. Each of the driving voltage lines 172 includes a plurality of second input electrodes 173b which extend toward the second control electrodes 124b. The driving voltage lines 172 overlap with the storage electrodes 127 and may be connected thereto.

The first and second output electrodes 175a and 175b are separated from each other, and are also separated from the data lines 171 and the driving voltage lines 172. The first input electrodes 173a and the first output electrodes 175a face each other with the first control electrodes 124a interposed therebetween. The second input electrodes 173b and the second output electrodes 175b face each other with the second control electrodes 124b interposed therebetween.

In one exemplary embodiment the data conductors 171, 172, 175a, and 175b may be made of a refractory metal such as molybdenum, chromium, tantalum, titanium, and alloys thereof. In another exemplary embodiment the data conductors 171, 172, 175a, and 175b may have a multilayered structure having a refractory metal layer (not shown) and a low-resistive conductive layer (not shown).

The first ohmic contacts and second ohmic contacts 165a, and 165b are disposed between the semiconductors 154a and 154b and the data conductors 171, 172, 175a, and 175b to reduce the contact resistance therebetween. The semiconductors 154a and 154b include exposed regions which are not covered with the data conductors 171, 172, 175a, and 175b, such as a region between the input electrodes 173a and 173b and the output electrodes 175a and 175b.

A passivation layer 180 is formed on the data conductors 171, 172, 175a, and 175b and the exposed regions of the semiconductors 154a and 154b. Exemplary embodiments of the passivation layer 180 are made of an inorganic insulator such as silicon nitride or silicon oxide, an organic insulator, or an insulating material having a low dielectric constant. Also, exemplary embodiments of the passivation layer 180 may have a dual-layered structure composed of a lower inorganic layer and an upper organic layer in order to protect the exposed regions of the semiconductors 154.

A plurality of contact holes 182, 185a, and 185b are formed on the passivation layer 180 to expose the ends 179 of the data lines 171, and the first and second output electrodes 175a and 175b, respectively. Also, a plurality of contact holes 181 and 184 are formed on the passivation layer 180 and the gate insulating layer 140 to expose the ends 129 of the gate lines 121 and the second control electrode 124b, respectively.

A plurality of pixel electrodes 191, a plurality of connecting members 85, and a plurality of contact assistants 81 and 82 are formed on the passivation layer 180. Exemplary embodiments of the pixel electrodes 191, the connecting members 85, and the contact assistants 81 and 82 are made of a transparent conductive material such as ITO or IZO, or a reflective metal such as aluminum, silver, or alloys thereof.

The pixel electrodes 191 are physically and electrically connected to the second output electrodes 175b through the contact holes 185b. The connecting members 85 are connected to the second control electrodes 124b and the first output electrodes 175a through the contact holes 184 and 185a, respectively.

The contact assistants 81 and 82 are connected to the ends 129 of the gate lines 121 and the ends 179 of the data lines 171 through the contact holes 181 and 182. The contact assistants 81 and 82 enhance the connectivity between the ends 129 of the gate lines 121 and an external device and between the ends 179 of the data lines 171 and an external device, and protect the ends 129 and 179 from damage.

A partition 361 is formed on the passivation layer 180. The partition 361 has openings 365 which define banks surrounding the edges of the pixel electrodes 191. Exemplary embodiments of the partition 361 may be made of an organic insulator or an inorganic insulator. In another exemplary embodiment the partition 361 may be made of a photoresist having a black pigment. In such an exemplary embodiment, the partition 361 functions as a light blocking member with a simple formation process.

Organic light emitting members 370 formed by the exemplary embodiment of an inkjet printing system according to the present invention are disposed in the openings 365 defined by the partition 361 on the pixel electrodes 191, similar to the process used to create the color filters 230 of the LCD described above. A solution containing a solvent and a solute comprising the organic light emitting material is dripped into the openings 365 of the partition 361. The solvent is then evaporated from the solution using the exemplary embodiment of an inkjet printing system utilizing both a vacuum and a heater to uniformly dry the solution and create a uniform light emitting member.

Exemplary embodiments of the organic light emitting members 370 are made of an organic material which emits light in one of three primary colors such as red, green, and blue. The OLED display may display images as a spatial sum of primary colors emitted from the organic light emitting members 370. In an alternative exemplary embodiment the organic light emitting member 370 may be made of an organic material which emits white light or a light which is a combination of primary colors; in such an exemplary embodiment no color filter, or a modified color filter, may be used.

The organic light emitting members 370 may have a multi-layered structure including an emitting layer (not shown) for emitting light and an auxiliary layer (not shown) for improving the light emitting efficiency of the emitting layer. Exemplary embodiments of the auxiliary layer may be electron and hole transport layers (not shown) for balancing the number of electrons and holes in the emitting layer and electron and hole injecting layers (not shown) for enhancing the injection of the electrons and holes.

A common electrode 270 is formed on the organic light emitting members 370. The common electrode 270 receives a common voltage Vss. Exemplary embodiments of the common electrode 270 are made of a reflective metal such as Ca, Ba, Mg, Al, and Ag or a transparent conductive material such as ITO and IZO.

In such an OLED display, the first control electrode 124a connected to the gate line 121, the first input electrode 173a connected to the data line 171, and the first output electrode 175a, together with the first semiconductor 154a form switching thin film transistors Qs. The channel of the switching thin film transistor Qs is formed in the first semiconductor 154a between the first input electrode 173a and the first output electrode 175a. The second control electrode 124b connected to the second output electrode 175b, the second input electrode 173b connected to the driving voltage line 172, and the second output electrode 175b connected to the pixel electrode 191, together with the second semiconductor 154b form a driving thin film transistor Qd. The channel of the driving thin film transistor Qd is formed in the second semiconductor 154b between the second input electrode 173b and the second output electrode 175b. The pixel electrode 191, the organic light emitting member 370, and the common electrode 270 form an OLED LD. The pixel electrode 191 becomes an anode, and the common electrode 270 becomes a cathode. Alternatively, the pixel electrode 191 may become a cathode, and the common electrode 270 may become an anode. The storage electrode 127 and driving voltage line 172 which overlap each other form a storage capacitor Cst.

An OLED display as described above displays images by emitting light upward or downward in relation to the substrate 110. Opaque pixel electrodes 191 and a transparent common electrode 270 are applied to a top emission type OLED display which displays images upward from the substrate 110. Transparent pixel electrodes 191 and an opaque common electrode 270 are applied to a bottom emission type OLED display which displays images downward from the substrate 110. Alternative exemplary embodiments include configurations wherein the OLED display displays images both upward and downward in relation to the substrate (e.g., on opposite sides) by including a transparent pixel electrode 191 and a transparent opaque electrode 270.

Although an exemplary embodiment of a display panel for an OLED display having semiconductors 154a and 154b made of amorphous silicon has been described, alternative exemplary embodiments include configurations wherein the display panel employs semiconductors made of polysilicon.

Using the exemplary embodiment of an inkjet printing system according to the present invention and a method of manufacturing a display device using the same, it is possible to dry ink faster by simultaneously using vacuum holes and a heater.

Also, it is possible to dry ink by utilizing a drying unit at almost the same time as a head unit drips the ink and to adjust the time and condition of the drying operation, thereby improving the uniformity of the profile and the thickness of the color filters.

While the present invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. An inkjet printing system comprising:
a substrate mounted on a stage;
a head unit dripping ink onto the substrate;
a drying unit drying the ink dripped onto the substrate; and
a moving device moving the head unit and the drying unit to predetermined positions,
wherein vacuum holes are formed in the drying unit.

2. The inkjet printing system of claim 1, wherein the drying unit is disposed away from the head unit at a predetermined interval in a direction substantially perpendicular to a moving direction of the head unit.

3. The inkjet printing system of claim 2, wherein the drying unit further comprises a heater.

4. The inkjet printing system of claim 3, wherein the heater is disposed between the vacuum holes.

5. The inkjet printing system of claim 3, wherein the head unit comprises an inkjet head having a plurality of nozzles.

6. The inkjet printing system of claim 1, wherein the substrate is one of a substrate for a liquid crystal display and a substrate for an organic light emitting diode display.

7. The inkjet printing system of claim 6, wherein the ink is one of ink for forming color filters and ink for forming organic light emitting members.

8. The inkjet printing system of claim 6, wherein a partition member is formed on the substrate to confine the dripped ink.

9. The inkjet printing system of claim 8, wherein the partition member is one of a light blocking member of a liquid crystal display and a partition of an organic light emitting diode display.

10. A method of manufacturing a display device, the method comprising:
disposing a head unit above a substrate;
dripping ink onto the substrate through the head unit while moving the head unit; and
drying the dripped ink with a drying unit adjacent to the head unit,
wherein vacuum holes are formed on the drying unit.

11. The method of claim 10, wherein the drying unit is disposed away from the head unit at a predetermined interval in a direction substantially perpendicular to a moving direction of the head unit.

12. The method of claim 11, further comprising heating the ink on the substrate through a heater on the drying unit.

13. The method of claim 12, wherein the head unit comprises an inkjet head having a plurality of nozzles.

14. The method of claim 10, wherein the substrate is one of a substrate for a liquid crystal display and a substrate for an organic light emitting diode display.

15. The method of claim 14, wherein the ink is one of ink for color filters and ink for organic light emitting members.

16. The method of claim 15, further comprising forming a partition member on the substrate to confine the dripped ink.

17. The method of claim 16, wherein the partition member is formed to be one of a light blocking member of a liquid crystal display and a partition of an organic light emitting diode display.
